(19) United States
(12) Patent Application Publication
(10) Pub. No.: US 2013/0305049 A1
(43) Pub. Date: Nov. 14, 2013

(54) SECURE MESSAGE TRANSFER AND STORAGE

(71) Applicant: Darius KRAKOWSKI, Hamburg (DE)

(72) Inventor: Darius KRAKOWSKI, Hamburg (DE)

(73) Assignee: OJOOO GMBH

(21) Appl. No.: 13/469,736

(22) Filed: May 11, 2012

(51) Int. Cl. H04L 9/00; G06F 15/16

(52) U.S. Cl. 713/170; 709/206

(57) ABSTRACT

Messages are transmitted from a computer sending device to a first main server. The first main server splits the message into a plurality of message parts and the plurality of message parts is transmitted to a plurality of parallel file servers. The message parts are stored in the file servers or are transmitted to a second main server. The second main server triggers the transmission of the plurality of message parts to the second main server and the second main server recombines the plurality of message parts to a complete message. The message is then transmitted from the second main server to the computer receiving device. The message transfer and the message part transfer are encrypted processes.

### BACKGROUND OF THE INVENTION

1. Field of the Invention

The present invention relates to a system and a method for the secure emission/receiving of messages and the server based storage of messages/data, wherein a participant can send messages/data to a server, such that they are stored in a special way and kind on the server.

2. Brief Description of the Background of the Invention Including Prior Art

In connection with the storing of sensitive data, for example patient and deadline data, it is important that third parties cannot obtain access to these data. Frequently however, the data have to be stored on a server as an external service provider in order to exploit scaling advantages during the storage, to reduce the administrative expenditure or to be able to access the data from arbitrary locations. It is frequently necessary to work with the most different computer systems in order to have worldwide access to the data. Here it is not possible to assume that a system supports certain hardware components or that software can be installed. Frequently, a web browser is the smallest common denominator for a data exchange between a client computer and a server.

The encrypted storage of data is common and widespread. Usually symmetrical encrypted algorithms such as for example AES are here employed. However, special software or special drivers, the presence of which cannot be assured everywhere, are required for the storage of data integrated with an operating system. The secure exchange of data is also widespread and is for example employed in the S/MIME method for the sending of encrypted e-mails. Asymmetric encrypting algorithms such as for example RSA are employed here. In this manner data can be exchanged between parties such that third parties cannot access these data.

The SSL method is the most widespread method to encrypt data, which are transmitted through the Internet. The server and sometimes also the client are authenticated through a public key infrastructure, and the data are encrypted during transmission with standardized algorithms. In this way the data cannot be changed or listened in by third parties. Only the transmission path to the server is secured with this method. The data are present on the server itself without encryption. This situation is insufficient for many security requirements.

Where data have to be stored securely on a server and have to be exchanged securely through the server, it has to be assured that the data are transmitted only encrypted to the server, that the data are deposited encrypted there, and are decrypted only on the clients connected to the server. Third parties which have access to the transmission path or to the server, cannot read the data. The keys, with which the data to be exchanged are encrypted, are stored at the clients in local persistent memories as applied in the methods and systems known in the state of the art. This is disadvantageous, since for example web browsers frequently will not have any local storage for keys, where one could access such keys out of a browser application.

There exist already programs, which split files. These programs are furnished to be applied for local use and which do not contribute to the protection or, respectively, to the security of the data to be split. Examples of this situation are the following applications: www.hjsplit.org, www.gdgsoft.com/gsplit/. These are not applications, which are based on a server. These programs are furnished for a local installation that is on the computer of the respective user. These applications split large files into several smaller files. The generated files after the splitting are still on the computer of the user. The file parts are not encrypted by these programs.

The user needs in turn an additional encryption program for encrypting the file parts. Furthermore, an additional e-mail program is required for mailing data to a receiver. The receiver needs after the receipt of the data file parts the same program in order to lead the data file parts again to a complete data file. There exists the danger that the data file after the mailing are located at one location, which is the mail server, and that unauthorized third persons can take possession of the data file.

### SUMMARY OF THE INVENTION

### 1. Purposes of the Invention

It is therefore an object of the present invention to enable a secure server based storage and a secure server based exchange of messages/data, without that keys for encrypting and decrypting of data have to be stored locally in a persistent memory storage on a client machine.

It is another object of the invention to improve the security of the inter-human electronic communication, which contains the sending, the receiving, and the storing of data.

### 2. Brief Description of the Invention

A computer system comprises a computer sending device connected to a first main server, which is in turn connected to a plurality of file servers disposed in parallel. The file servers are connected to a second main server and the second main server is connected to a computer receiving device. Messages are transmitted from the computer sending device through the first main server, the parallel file servers, the second main server to the computer receiving device.

The first main computer splits the message signal into a plurality of message part signals, which each are recorded by a corresponding file server. The message part signals are delivered from the plurality of file servers to the second main server, where the message part signals are again recombined to the message signal. The second main server delivers the message signal to the computer receiving device. All transmissions of the message signal and of the message the plurality of message parts is stored on the plurality of file servers, wherein the plurality of message parts is transmitted from the plurality of file servers to the second main server, wherein the plurality of message parts is transmitted into the message in the second main server followed by delivering the message from the second main server to the computer receiving device.

### BRIEF DESCRIPTION OF THE DRAWING

FIG. 1 is a view of a schematic diagram of a secure transmission and storage system,

FIG. 2 is a view of a message received for transmission,

FIG. 3 is a view of a signal M1 delivered from a user U1 to the first main server MS1,

FIG. 4 is a view of the first main server MS1 delivering message parts to a plurality of file servers FS1 to FS-n,

FIG. 5 is a view of the file servers delivering message parts from the file servers FS1 to FS-n,

FIG. 6 is a schematic view of the message M1 delivered for receiving,

FIG. 7 is a schematic diagram of the message M1 being transmitted from a second main server MS2,

FIG. 8 is a flow diagram of steps performed by the first main server MS1,

FIG. 9 is a flow diagram of steps performed by the second main server MS2,

FIG. 10 is a flow diagram of steps for establishing the number of the plurality of message parts to be used.

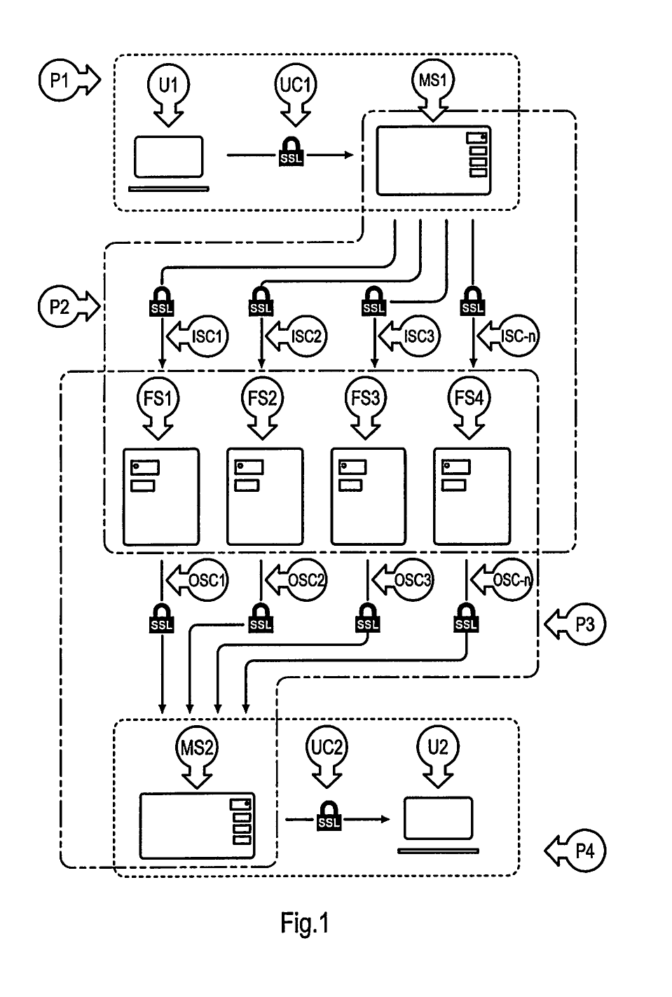

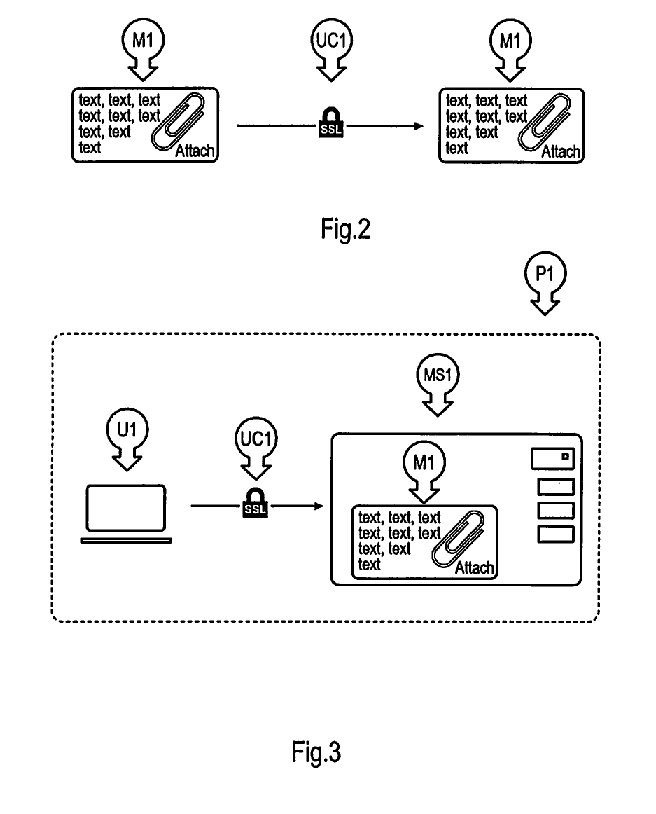

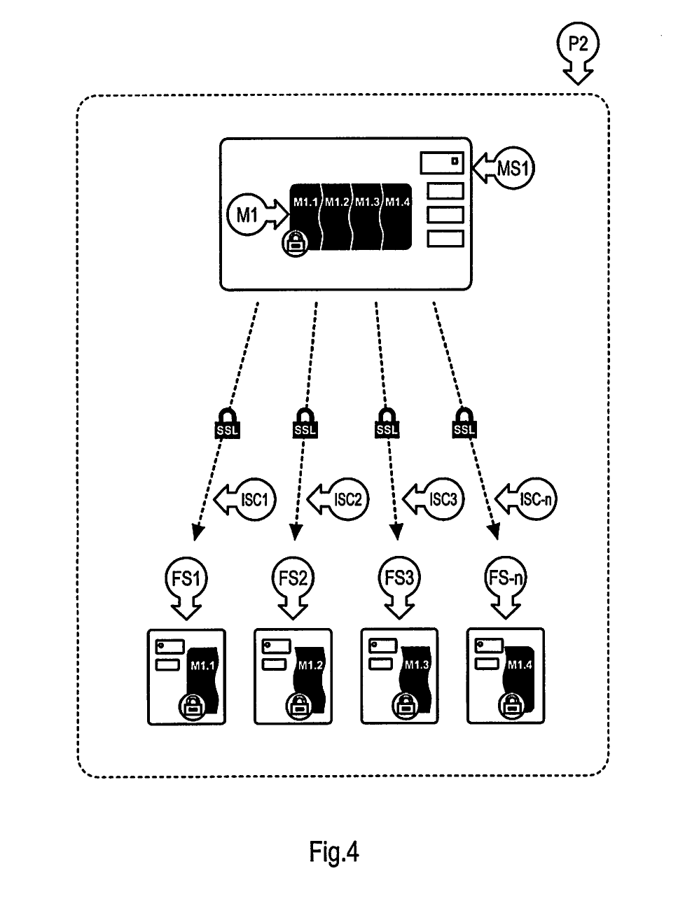

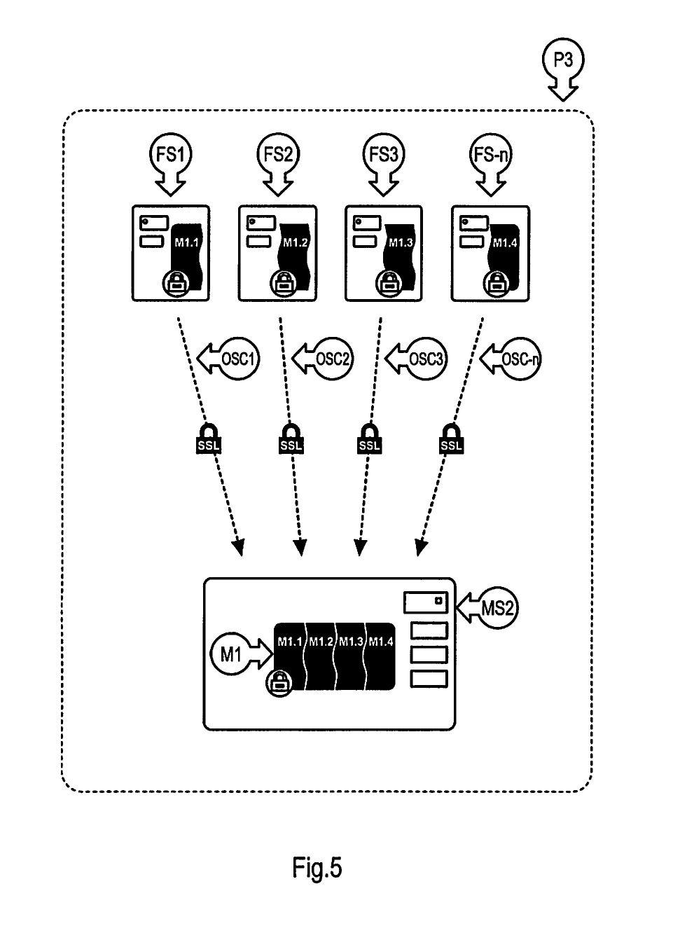

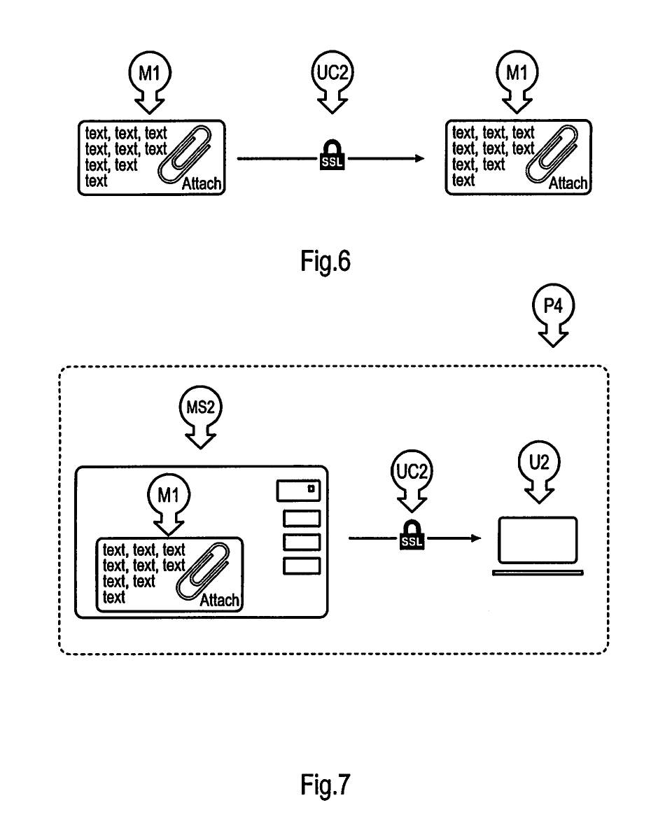

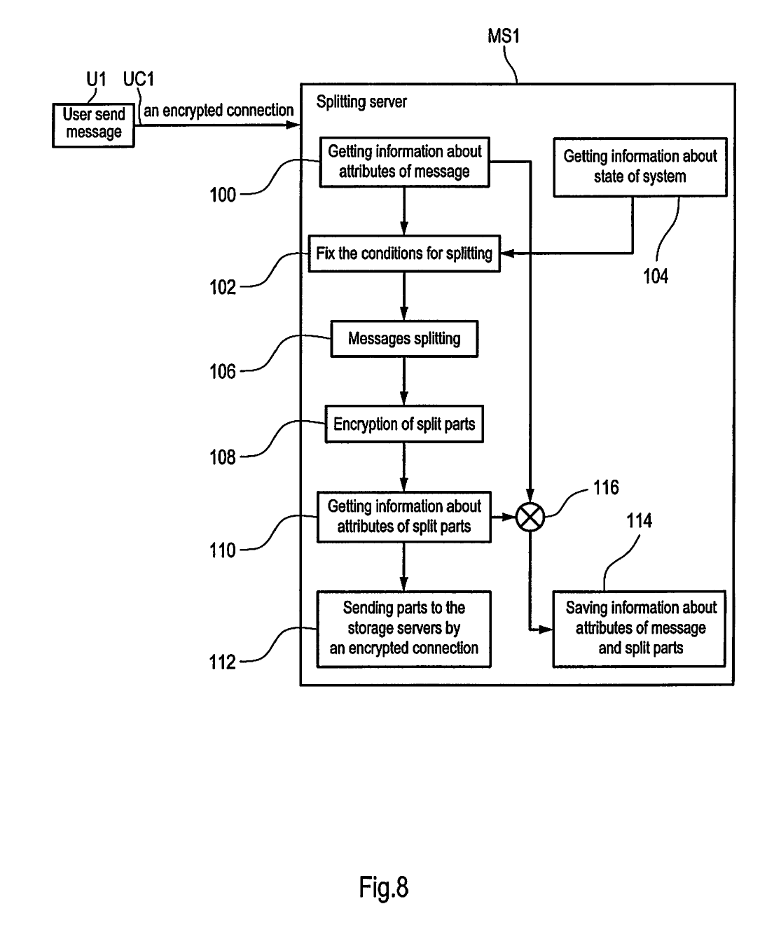

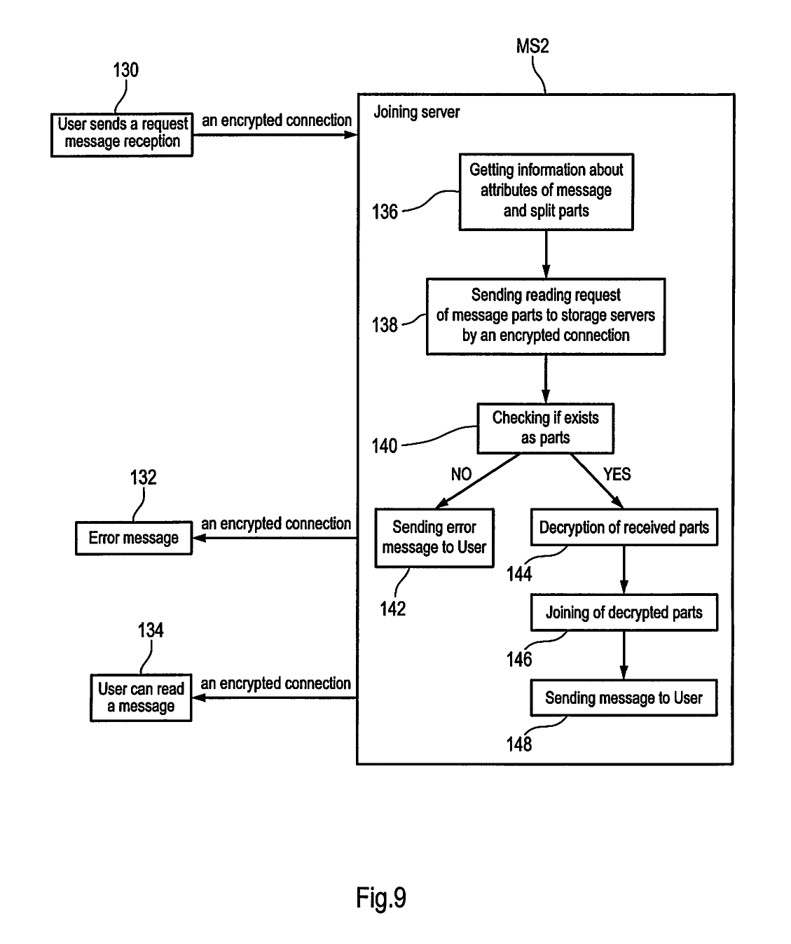

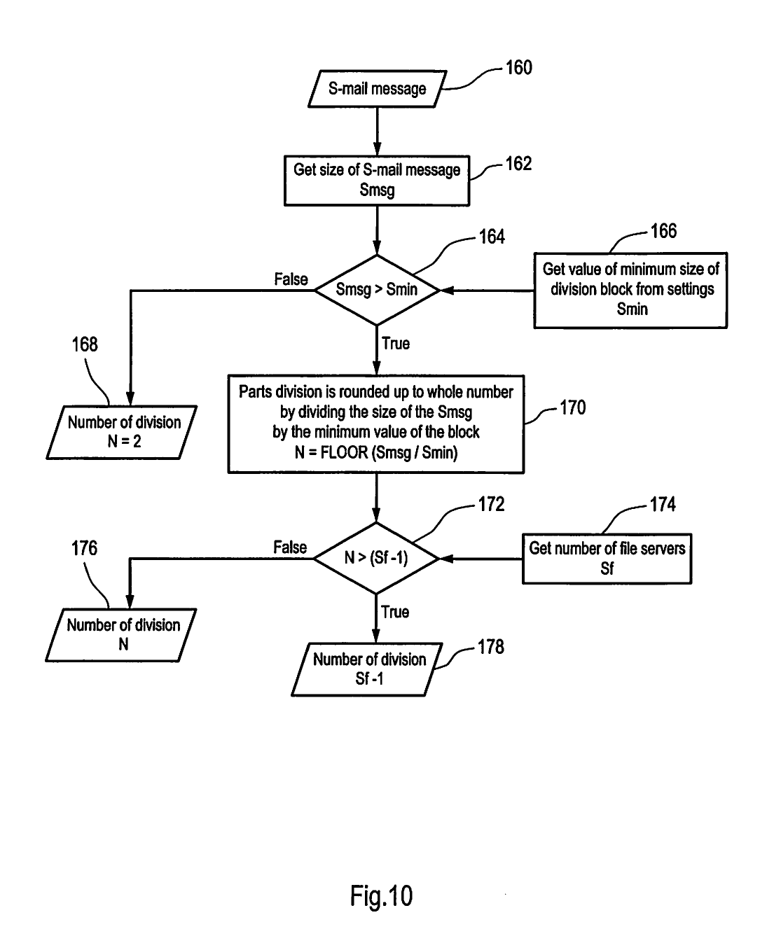

### DESCRIPTION OF INVENTION AND PREFERRED EMBODIMENT

A secure storage and communication system is furnished. A message and/or data signal is emitted by a computer sending device U1 and the emitted signals are fed UC1 to a first main server MS1. The first main server conditions the message or data signal into a number of part signals ISC1 to ISC-n, which part signals are fed into a number of separate computers operating as file servers FS1 to FS-n and storing the part signals ISC1 to ISC-n delivered by the first main server MS1. The file servers FS1 to FS-n store the corresponding part signals ISC1 to ISC-n. A second main server MS2 calls the part signals OSC1 to OSC-n from the file servers FS1 to FS-n. The second main server MS2 joins the part signals OSC1 to OSC-n together and feeds the joined signal through the SSL encrypted connection UC2 to a receiver U2.

A data/message input U1 is an input computer or telephone furnished with data/messages. The input computer is operating on an operating system and is connected to the Internet through an Internet browser.

The input data/messages entered into the input computer are furnished to an input data connection UC1. The data input connection UC1 is an SSL encrypted Internet connection. A second end of the data input connection UC1 is connected to a first main server MS1. The first main server MS1 is a computer, which subdivides the data message delivered through the data input connection UC1 into a number of n separate first message parts. Such a first main server MS1 is placed in a computer center and is connected to the Internet. The Internet connection should have a speed of minimum 100 Mbit. No peripherals are needed by the first main server MS1, since it can be controlled from another computer through a network. This first main server can have the following configuration: processor minimum four cores and minimum 2 GHz, RAM storage minimum 4 GB, hard disk minimum 10 GB. The required software on the first main server can be the following:
operating system OpenSuse Linux at least version 11.4
PHP at least the version 5.2, with integrated modules: CLI, mhash, mcrypt web server Apache at least in the version 2
OpenSSL
data base MySQL at least in the version 5.0
Java Oracle at least in the version 1.6

A first self developed program is responsible for the subdivision or splitting of files and which stores the message parts.

In a process step 100, the first main server MS1 gets information about attributes of a message. These attributes of the message are transferred to a step 102 and information 104 about the state of the system are transferred to the step 102, which fixes or sets the conditions for splitting the message M1. The messages are split in the step 106 following to the step 102. The message parts are encrypted in step 108 following to step 106. Information about attributes of split parts is obtained in step 110. Then in the following step 112, where the message parts are sent to the storage file servers by an encrypted connection. The junction 116 receives information about the attributes of the message in step 100 and receives information about attributes of split message parts in step 110 and delivers the information to step 114, which saves the information about attributes of messages and split message parts.

The first main server MS1 is connected to a plurality of n feeding connections ISC1 to ISC-n, which are secured by SSL. The first main server MS1 delivers n signals to respective feeding connections ISC1 to ISC-n Each of the feeding connections ISC1 to ISC-n is connected to a separate data holding file server FS1 to FS-n, where n is a number 4 or larger.

The data holding servers FS1 to FS-n store the corresponding n message part signals. A triggering signal from a second main server MS2 is delivered to the data holding servers FS1 to FS-n to deliver n part signals to the discharging connections OSC1 to OSC-n. The discharging connections OSC1 to OSC-n deliver the n part signals to a second main computer server MS2, where the n message part signals are rejoined to form the message or data signal. The second main server MS2 is a computer, which joins the data delivered through the discharging connections OSC1 to OSC-n into the data or message signal. Such a second main server MS2 is placed in a computer center and is connected to the Internet. The Internet connection should have a speed of minimum 100 Mbit. No peripherals are needed by the second main server MS2, since it can be controlled from another computer through a network.

The receiver user U2 sends a request for receiving a message through an encrypted connection to the second main server MS2. The second main server MS2 includes a joining server, which gets information about attributes of message and split message parts.

The receiver user U2 sends a request message reception through an encrypted connection to the joining server to provide a step 136 getting information about the attributes of message and split message parts. Then a reading request of message parts is sent to the storage file server by an encrypted connection in a step 138. Then a checking is performed if the concerned message part exists in the file servers FS1 to FS-n in a step 140. If not then an error message is sent to the user U2 in step 142. If the step 140 shows that the message part exists then the received message part is decrypted in a step 144. The decrypted parts are joined in a following step 146. The joined decrypted message parts are then sent as a message to the user in step 148.

This second main server MS2 can have the following configuration: processor minimum four cores and minimum 2 GHz, RAM storage minimum 4 GB, hard disk minimum 10 GB. The required software on the
second main server can be the following:
operating system OpenSuse Linux at least version 11.4
PHP at least the version 5.2, with integrated modules: CLI, mhash, mcrypt web server Apache at least in the version 2
OpenSSL
data base MySQL at least in the version 5.0
Java Oracle at least in the version 1.6

A second self developed program, which is responsible for the joining of the storage of the message parts and for the combining of previously separated parts of files.

The message or data signal is delivered to the output connection UC2, which is an Internet connection encrypted by SSL. The output connection delivers the message or data signal to a receiver computer U2.

The invention can be applied in all areas, both private as well as commercial, where the security of the electronically sent out information is important. A conceivable application can be a company internal communication, for example in a law office, a medical establishment, a hospital, and insurance company and the like, that is always there where important and sensible data are sent through the Internet and are stored on a server, which is connected to be Internet and which is therefore freely accessible for possible attackers.

In the following the components employed in the invention are described in more detail.

U1

a user of the system which sends a message or data.

Requirements: a functioning computer with a monitor, keyboard, mouse, with an arbitrary operating system (for example: Windows XP, Windows 7, Mac 10.7.3 OSX), an Internet browser (for example: Firefox, Internet explorer, Opera) Internet connection.

U2

User of the system, who receives a message/data.

Requirements: a functioning computer with a monitor, keyboard, mouse, with an arbitrary operating system (for example: Windows XP, Windows 7, Mac OS X 10.7.3, and Internet browser (for example: Firefox, Internet Explorer, Opera), Internet connection.

FS1 to FS-n

File servers, which hold the parts of the subdivided messages/data, are so-called data holding servers. Such a data holding server is a computer, which is placed in a computer center and which is connected to the Internet. The connection should have at least 100 MBit speed. This computer does not need any peripheral apparatus, since the computer can be served by another computer through the net work by an administrator. This file server can have the following configuration, processor minimum four cores and at least 2 GHz, RAM storage minimum 4 GB, hard disk minimum 10 GB. The required software on this server can be as follows:

operating system OpenSuse Linux at least version 11.4

Java Oracle at least version 1.6

OpenSSL

Apache Solr, serves for indexing the messages and for searching the message content in the messages

A third self developed program, which is responsible for the administration of the storage of the parts of a message generated by the first main server MS1.

MS1

The first main server, which subdivides sent messages/data and in the following distributes the sent messages/data onto the so-called data holding servers FS1 to FS-n.

Such a server MS1 is a computer, which is placed in a computer center and which is connected to the Internet. The connection should have a speed of at least 100 MBit. This computer does not require any peripheral apparatus, since the computer can be operated from another computer by an administrator through a network. This server can have the following configuration: processor minimum four cores and minimum 2 GHz, RAM storage minimum 4 GB, hard disk minimum 10 GB. The required software on the server can be the following:

operating system OpenSuse Linux at least version 11.4

PHP at least the version 5.2, with integrated modules: CLI, mhash, mcrypt web server Apache at least in the version 2

OpenSSL

data base MySQL at least in the version 5.0

Java Oracle at least in the version 1.6

A first self developed program, which is responsible for the subdivision, the storage of the message parts.

MS2

The second main server, which combines the message parts/data from the data holding servers and in the following transmits the combined message parts/data coming from the so-called data holding servers. At the call of the message parts/data, they are called from the data holding file servers into the second main server for reconnecting them again in the second main server and for transmitting this message to the user receiver thereupon. Such a main server is a computer, which is placed in a computer center and which is connected to the Internet. The connection should have a speed of at least 100 MBit. This computer does not require any peripheral apparatus, since the computer can be operated from another computer by an administrator through a network. This main server can have the following configuration: processor minimum four cores and minimum 2 GHz, RAM storage minimum 4 GB, hard disk minimum 10 GB. The required software

on the server can be the following:

operating system OpenSuse Linux at least version 11.4

PHP at least the version 5.2, with integrated modules: CLI, mhash, mcrypt web server Apache at least in the version 2

OpenSSL

data base MySQL at least in the version 5.0

Java Oracle at least in the version 1.6

A second self developed program, which is responsible for the transfer and joining of the message parts and for delivery of the messages to the user receiver.

UC1

data connection between the user (here sender) and the first main server. This connection is an Internet connection secured by SSL

UC2

data connection between the user (here receiver) and the second main server. This connection is an Internet connection secured by SSL.

ISC1 to ISC-n

data connection secured by SSL between the first main server and the data holding servers, which are responsible for the holding of the parts of the subdivided message/data, in a number of at least 4 to n.

OSC1 to OSCn

data connection secured by SSL between the second main server and the data holding servers, which are responsible for the holding of the parts of the subdivided message/data, in a number of at least 4 to n.

Process steps of the splitting, storing and recombination

P1

This process involves the sending process of a message/data. It includes the process/data exchange between the user (sender) and the first main server. The message M1 is transferred from the sender U1 in the frame of a sending process P1 over an SSL secured data connection UC to the first main server MS1. This is an Internet connection, which is secured by SSL.

P2

A splitting or subdivision process and the distribution of the data message parts through the first main server onto the data holding servers. The first main server MS1 is responsible for the splitting of the messages and receives the message to be subdivided within the framework of the process P1. The message is first analyzed within the frame of the process P2, that is information about the message attributes are read. The state of the physical system is analyzed in parallel, that is the number of data holding servers FS1 to FS-n and their actual load are determined. These data are encrypted and are stored in a first databank of the first main server MS1. In the following the subdivision rules of the message are fixedly written. The message is subdivided into parts according to previously fixed rules. Each of the message parts is encrypted by the system with the aid of the AES encrypting method by employing in each case its own key. A random sequence of characters is employed as a key with a length of 256 Bit. The first main server analyzes the message M1 within the frame of the process P2 and the first main server MS1 decrypts the message depending on the result of the analysis, subdivides the message in n parts (M1.1, M1.2, M1.3, M1.4) and encrypts the individual parts again. After the subdivision process, the n parts of the message are transferred onto the data holding servers FS1 to FS-n through an SSL secured data connection ISC1 to ISC-n and are stored there. This is an Internet connection, which is secured by SSL. Thereupon the information/attributes relating to the individual message

parts are stored in the first data bank of the first main server MS1. According to the rules fixed in the preceding step, the encrypted message parts are sent in the next step onto the data holding server and are stored there.

P3

Performing a calling of the data message parts from the data holding servers FS-1 to FS-n onto a second main server MS2 and joining of these message parts to a complete message again in the second main server MS2.

A user U2 requests the call of a message within the scope of the process P4.

A corresponding inquiry is sent to the second main server MS2 through an SSL-secured connection UC2. The second main server MS2, which is responsible for the joining of all message parts to a readable complete message, calls initially all required information about the requested message, which were stored in the first data bank of the first main server M1 within the scope of the subdivision process P2.

During the request/call of the message/data M1 from the receiver, the second main server MS2 within the frame of the process P3 all required message parts (M1.1, M1.2, M1.3, M1.4) of a message from the data holding servers FS1 to FS-n through a SSL secured connection OSC1 to OSC-n and join the message parts again together to a readable message/data M1. This is an Internet connection, which is secured by SSL.

The second main server MS2 calls all message parts of a message from the data holding plurality of file servers FS1 to FS-n in the scope of the joining process P3 through a SSL secured connection OSC1 to OSC-n with the aid of this information (In the case of an error, that is the lacking of one or several message parts, the second main server M2 sends a corresponding communication to the user U2). In each case all message parts of a message are decoded in the next step in order to be again united in the following to a complete readable message. After the successful reunification this message is sent to the user U2 through an SSL secured connection.

P4

The second main server MS2 then sends the joined message/data M1 to the receiver U2 through the SSL secured data connection UC2 within the frame of the calling process P3. This is an Internet connection, which is secured by SSL.

Perform a calling process of a message/data. Furnish process/data exchange between the user (receiver) and the second main server MS2.

Secure server based sending and storage of messages/data.

A server based system, comprising the processes P3 and P4 for the secure storage of messages/data includes at least one or several main servers MS1, MS2 and at least 4 or several data holding servers FS1 to FS-n. The messages/data are transmitted by the sender U1 within the frame of the sending process P1 to the first main server MS1 over a data connection UC1 secured by SSL. The first main server MS1 analyzes the message/data and encrypts the message depending on the result of the analysis, subdivides the message in n parts and encrypts again the individual parts. The n parts of the message are transferred and stored in the data holding servers FS1 to FS-n after the subdivision process through an SSL secured data connection ISC1 to ISC-n. Upon a request/call of the expected message/data by the receiver U2, the second main server MS2 calls all required message parts of a message from the data holding servers FS1 to FS-n through an SSL secured connection OSC1 to OSC-n) and joins the message parts again together to a readable message/data. The second main server MS2 sends the joined message/data in the following the receiver U2 within the frame of the calling process P2 over the SSL secured data connection UC2.

Function of the setting for the splitting or subdivision of the message/data The splitting functionality is installed on the first main server and is responsible for the sending, the dividing, distributing of the message parts on the data holding servers. The rejoining functionality is installed on the second main server and is responsible for the receiving the message parts from the data holding servers and for the rejoining of the message parts to a full message.

After the splitting of the message and the encrypting of the message parts and the following distribution of the message parts on the data holding servers, the reading of the data by unauthorized third parties is made difficult or, respectively, rendered impossible, that only where all message parts are present, are decrypted and are led together with the aid of the second main server, then the data are readable again. One or several message parts do not allow any conclusions relative to the contents of or other information about this message, since the message cannot be led together.

The number of the parts of a message depends on the number of the data holding servers FS1 to FS-n and on the side of the message Smsg itself.

The number of the message parts is always by one smaller than the number of the data holding servers Fs and depends on the parameter “Smin”, which defines the size of a message part.

The parameter Smin can be given/can be changed by the administrator of the system. This parameter describes the size of a message part of a message. Since there can be always messages, which have a size Smsg, which is smaller than the parameter Smin, there has to be a solution for this case. All messages, which are smaller than the value of the parameter Smin are subdivided into two parts.

The Smsg message is established in step 160 and is delivered to step 162, where the size of a mail message Smsg is established. The condition step 164 receives the mail message Smsg from step 162 and the value of minimum size of division block from settings Smin in step 166 and decides if Smsg is larger than Smin. If Smsg is smaller than Smin, then the condition step 164 is false and step 168 shows the Number of Division N=2. If Smsg is larger than Smin and step 164 is true, then the parts division is rounded up to a whole number by dividing the size of the Smsg by the minimum value of the block in step 170. The Number of division N=FLOOR (Smsg/Smin). The condition step 172 receives input from the step 170 and the number of the file servers FS in step 174. The condition that N is larger than Sf−1 can be false and then the Number of division is N in step 176. When the condition that N is larger than Sf−1 is true, then the Number of division is Sf−1 in step 178.

### EXAMPLES

### Example 1

(Size of the message) Smsg: 1124 kB

(size of the message parts) Smin: 100 kB

(number of the data holding servers) Fs: 6

Smsg 1124 kB/Smin 100 kB N=12 (possible message parts)

Fs−1=5

N>5

This message is subdivided into 5 parts.

### Example 2

(Size of the message) Smsg: 90 kB

(size of the message parts) Smin: 100 kB

(number of the data holding servers) Fs: 6

Smsg 90 kB<Smin 100 kB

This message is subdivided into 2 parts.

### Example 3

(Size of the message) Smsg: 324 kB

(size of the message parts) Smin: 100 kB

(number of the data holding servers) Fs: 6

SMSG 1124 kB/Smin 100 kB→N=4 (possible message parts)

Fs−1=5

N<5

This message is subdivided into 4 parts.

### Example 4

(Size of the message) Smsg: 324 kB

(size of the message parts) Smin: 50 kB

(number of the data holding servers) Fs: 16

Smsg 324 kB/Smin 50 kB→N=12 (or similar message parts) Fs−1=15

N<15

This message is subdivided into 7 parts.

1. A computing system comprising
a computer sending device;
a first main server connected to the computer sending device;
a plurality of file servers disposed in parallel and each connected to the first main server;
a second main server connected to the plurality of file servers;
a computer receiving device connected to the second main server;
wherein a message is sent from the computer sending device to the first main server;
wherein the message is split in the first main server into a plurality of message parts;
wherein the plurality of message parts is sent from the first main server to the plurality of file servers;
wherein the plurality of message parts is sent from the plurality of file servers to the second main server;
wherein the plurality of message parts is recombined in the second main server to the message;
wherein the message is sent from the second main server to the computer receiving device.

2. The computing system according to claim 1 wherein
wherein an encrypted message is sent from the computer sending device to the first main server;
wherein the message is split in the first main server into a plurality of encrypted message parts;
wherein the plurality of encrypted message parts is sent from the first main server to the plurality of file servers;
wherein the plurality of encrypted message parts is sent from the plurality of file servers to the second main server;
wherein the plurality of encrypted message parts is recombined in the second main server to the message;
wherein the encrypted message is sent from the second main server to the computer receiving device.

3. The computing system according to claim 1 further comprising
a first databank associated with the first main server; and
a second databank associated with the second main server.

4. The computing system according to claim 3,
wherein the message is first analyzed;
wherein information about message attributes is read;
wherein the state of the system is analyzed in the file servers in parallel;
wherein the actual load of the file servers is determined;
wherein each of the message parts is encrypted by the system with the aid of the AES encrypting method;
wherein a random sequence of characters is employed as a key with a length of 256 Bit;
wherein the information or attributes relating to individual message parts are stored in the first data bank of the first main server;
wherein the encrypted message parts are sent onto the respective data holding file server;
wherein the message parts are stored on the respective data holding file server.

5. The computing system according to claim 3, wherein
the receiver user calls the second main server for joining of the message parts to obtain a complete message;
wherein the second main server calls the first main server about required information which was stored in the first main server;
wherein the second main server calls all message parts of the message from the data holding servers in the scope of the joining process;
wherein the message is sent to the user receiver after the successful reunification.

6. A method of securely sending, storing and receiving messages comprising inputting a message into a computer emitting device;
delivering the message to a first main server;
transforming the message into a plurality of message parts in the first main server;
transmitting the plurality of message parts from the first main server to a plurality of file servers;
storing the plurality of message parts on the plurality of file servers;
transmitting the plurality of message parts from the plurality of file servers to the second main server;
transforming the plurality of message parts into the message in the second main server;
delivering the message from the second main server to the computer receiving device.

7. The method according to claim 6 further comprising
encrypting the delivery of the message from the computer emitting device to the first main server;
encrypting the transmitting of the plurality of message parts from the first main server to the plurality of file servers;
encrypting the transmitting of the plurality of message parts from the plurality of file servers to the second main server;
encrypting the delivery of the message from the second main computer to the computer receiving device.
